(19) United States
(12) Patent Application Publication
(10) Pub. No.: US 2016/0295500 A1
(43) Pub. Date: Oct. 6, 2016

(54) DISCOVERY PERIOD CONFIGURATION FOR SMALL CELL ON/OFF

(71) Applicant: NEC CORPORATION, Minato-ku, Tokyo (JP)

(72) Inventors: Le LIU, Tokyo (JP); Naoto ISHII, Tokyo (JP); Hisashi FUTAKI, Tokyo (JP); Jun SHIKIDA, Tokyo (JP)

(73) Assignee: NEC Corporation, TOKYO (JP)

(21) Appl. No.: 15/023,275

(22) PCT Filed: Sep. 25, 2013
(86) PCT No.: PCT/JP2013/005679

§ 371 Date: Mar. 18, 2016

(51) Int. Cl. H04W 48/16; H04W 28/02

(52) U.S. Cl. CPC H04W 48/16; H04W 28/0289

(57) ABSTRACT

In one embodiment, an apparatus, a system or a network (1) sets a discovery period for a node (2B). The discovery period is a time period in which the node (2B) sends a signal (e.g., PSS, SSS, and CRS) necessary for cell detection and radio measurement performed by a user equipment (3A) before a cell (20B), controlled by the node (2B), is to be turned on in order to send a signal (e.g., data signal) for either or both of user data reception and transmission. It is achieved, for example, that the user equipment (3A) is able to detect the signal (e.g., PSS, SSS, and CRS) for cell detection and radio measurement in the discovery period by using legacy behavior of radio measurement.

### TECHNICAL FIELD

The present disclosure relates generally to a wireless communication system and, more specifically, to techniques of small cell on/off in Heterogeneous network.

### BACKGROUND ART

Heterogeneous network with dense small cells 92 controlled by low power nodes (LPNs) 82 located in a macro cell 91 have been attracting much attention, as illustrated in FIG. 1. The macro cell 91 is controlled by a macro eNodeB (MeNB) 81. In 3GPP LTE Release 12 small cell enhancement study item (SCE SI), small cell on/off is a potential technique to avoid interference among small cells and ensure efficient operation for power saving. As introduced in NPL 1, small cell on/off technique includes turning on and off a small cell 92, where a cell here may refer to a component carrier (CC). As described in NPL 2, when a small cell 92 is on, an LPN 82 transmits signals necessary for a User Equipment (UE) 83 to receive data from the small cell 92, such as the reference signals used for measurements and demodulation. While, when a small cell 92 is off, an LPN 82 does not transmit signals necessary for a UE to receive data from the small cell 92.

As illustrated in NPL 1, a UE 83, which is capable of inter-eNB carrier aggregation (or dual-connectivity), can camp on the macro cell 91 as a primary cell (PCell) and move to RRC_CONNECTED mode. When the inter-eNB carrier-aggregation (CA)-capable UE 83 is in RRC_CONNECTED mode with the PCell, the MeNB 81 can configure/release a secondary cell (SCell) for the UE.

In NPL 3, the small cell on/off schemes have been considered to turn on/off small cells 92 semi-statically. An example of semi-static small cell on/off is illustrated in FIGS. 2A and 2B, where a small cell 92A controlled by an LPN 82A is turned from on to off at timing of T1; while a small cell 92B controlled by an LPN 82B is turned from off to on at the time T1 to avoid the inter-cell interference between the small cells 92A and 92B. In case of small cell on/off, even for a UE with low mobility, the SCell configuration or SCell reselection to a just turned-on neighbor small cell may be needed.

As in FIGS. 2A and 2B, both a UE 83A and a UE 83B are CA-capable UEs and camp on the MeNB 81 as the PCell. The UE 83A is also served by the LPN 82A as SCell before T1. After T1, the LPN 82A is turned off so that remained data of the UE 83A cannot be sent from the LPN 82A, and the UE 83A thereby needs to reselect the neighbor LPN 82B as its SCell. Different from UE 83A, UE 83B is only served by the MeNB 81 as PCell before T1. After T1, the LPN 82B is turned on and the MeNB 81 can configure the LPN 82B for the UE 83B as its SCell. Therefore, both the UEs 83A and 83B need to detect the LPN 82B.

In Long Term Evolution (LTE), the UEs 83A and 83B need to detect a cell by searching a primary synchronization signal (PSS) and a secondary synchronization signal (SSS), defined in 3GPP specification TS 36.211, to identify a physical cell ID and frame boundary for timing synchronization. Next, the UEs 83A and 83B detect a cell-specific reference signal (CRS) by using the physical cell ID. Then, the UEs 83A and 83B carry out channel estimation based on the CRS to detect a physical downlink broadcast channel (PBCH), over which cell specific system information are transmitted.

After performing the cell synchronization and knowing the system information, the UEs 83A and 83B start radio resource management (RRM) measurement at T2 by using the CRS. In the RRM measurement, the UEs 83A and 83B each measures, for example, either or both of reference signal received power (RSRP) and reference signal received quality (RSRQ), as defined in 3GPP specification TS 36.133, and sends the measured RSRP and/or RSRQ to the serving cell (i.e., the macro cell 81 as the PCell). The reported RSRP and/or RSRQ are used by the MeNB 81 to rank between the different cells as input for cell reselection (i.e., SCell addition/modification) decisions. The process of cell detection/synchronization and RRM measurement costs time before the UEs 83A and 83B are connected to LPN 82B as their new SCell.

As illustrated in FIGS. 2A and 2B, the UE 83A measures RSRP/RSRQ of the LPN 82A before T1 and starts to detect the LPN 82B after T1 when RSRP/RSRQ of the LPN 82A drops. The cell reselection (i.e., SCell modification) is completed after T3 by comparing the reported RSRP/RSRQ at the MeNB 81 so that UE 83A can access from the LPN 82A to the LPN 82B as the new SCell.

At the UE 83B, the SCell is initially configured by the MeNB 81 after the LPN 82B is turned on. However, the initial SCell configuration also costs time due to the similar process of cell synchronization and RRM measurement/reporting.

The cost time results in the traffic time delay for UEs 83A and 83B to send or receive a new traffic data (i.e., user data) to or from LPN 82B.

In NPL 4, a scheme is considered to solve the above problem of traffic time delay. As indicated by an oval with the symbol C illustrated in FIG. 3, in the OFF period, the LPN 82B still sends the signals for cell detection and RRM measurement, such as PSS, SSS, PBCH and CRS, with a long duty cycle to achieve fast cell selection. The correct RRM measurements are required to be reported during OFF period to access the just turned-on LPNs.

### CITATION LIST

### Non Patent Literature

[NPL 1] 3GPP R1-133921, Huawei, HiSilicon, NTT DOCOMO, CATR, “Draft text proposal on small cell on/off”, 3GPP TSG RAN WG1 Meeting #74, Barcelona, Spain, 19-23 Aug. 2013
[NPL 2] 3GPP R1-132888, Huawei, HiSilicon, “Enhancements of small cell on/off”, 3GPP TSG RAN WG1 Meeting #74, Barcelona, Spain, 19-23 Aug. 2013
[NPL 3] 3GPP R1-133882, Huawei, HiSilicon, NTT DOCOMO, CATR, “Draft text proposal on small cell on/off performance”, 3GPP TSG RAN WG1 Meeting #74, Barcelona, Spain, 19-23 Aug. 2013
[NPL 4] 3GPP R1-133024, CATT, “small cell discovery”, 3GPP TSG RAN WG1 Meeting #74, Barcelona, Spain, 19-23 Aug. 2013

### SUMMARY OF INVENTION

### Technical Problem

However, by detecting the signals with long duty cycle during the OFF period, the legacy UE behavior of RRM measurement until LTE Release 11 may input the zero samples of RSRP/RSRQ into the layer-1 (L1) filtering, which results in poor accuracy of RRM measurements. On the other hand, the new UE behavior of RRM measurements needs to be supported to input the correct samples of the signals with long duty cycle into the L1 filtering.

### Solution to Problem

In one embodiment, an apparatus, a system or a network is configured to set a discovery period for a node to send a signal(s) necessary for cell detection and radio measurement performed by a UE before a cell, controlled by the node, is to be turned on in order to send a signal(s) for either or both of user data reception and transmission.

### Advantageous Effects of Invention

According to the above embodiment, a UE is able to detect the signal(s) for cell detection and RRM measurement in the configured discovery period by using legacy UE behavior of RRM measurement until LTE Release 11 to access a just turned-on cell with reduced traffic delay.

This has outlined the features and technical advantages of the present disclosure in order that the following description may be better understood. The features and advantages of the present disclosure will be more apparent from the following description in conjunction with the accompanying drawings. It is to be expressly understood, however, that each of the drawings is provided for the purpose of illustration and description only and is not intended as a definition of the limits of the present disclosure.

### BRIEF DESCRIPTION OF DRAWINGS

FIG. 1 is a schematic diagram illustrating an example of a heterogeneous network including a macro cell and small cells.

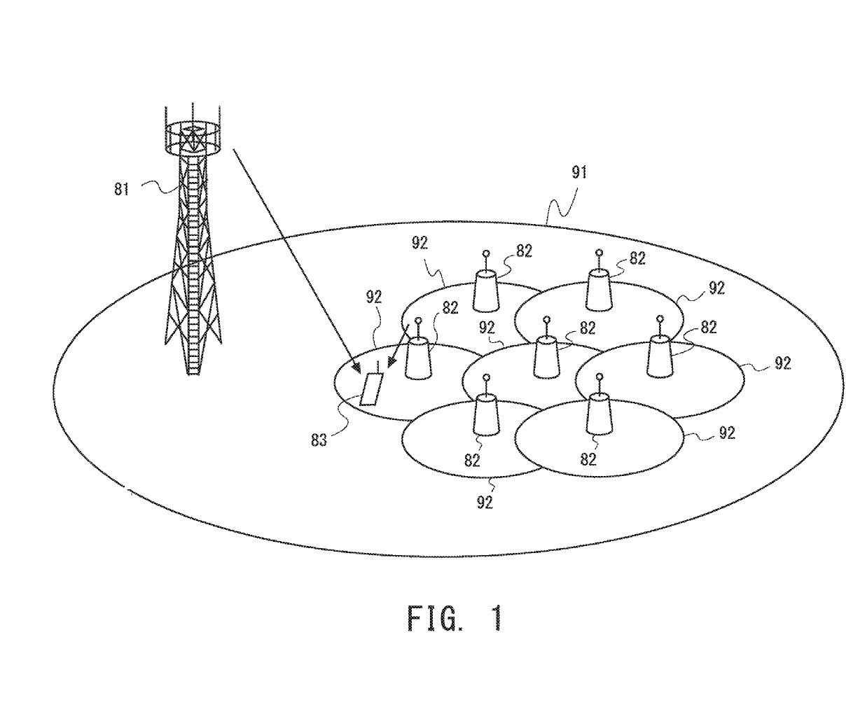

FIG. 2A is a diagram conceptually illustrating a small cell ON/OFF behavior of a low power node.

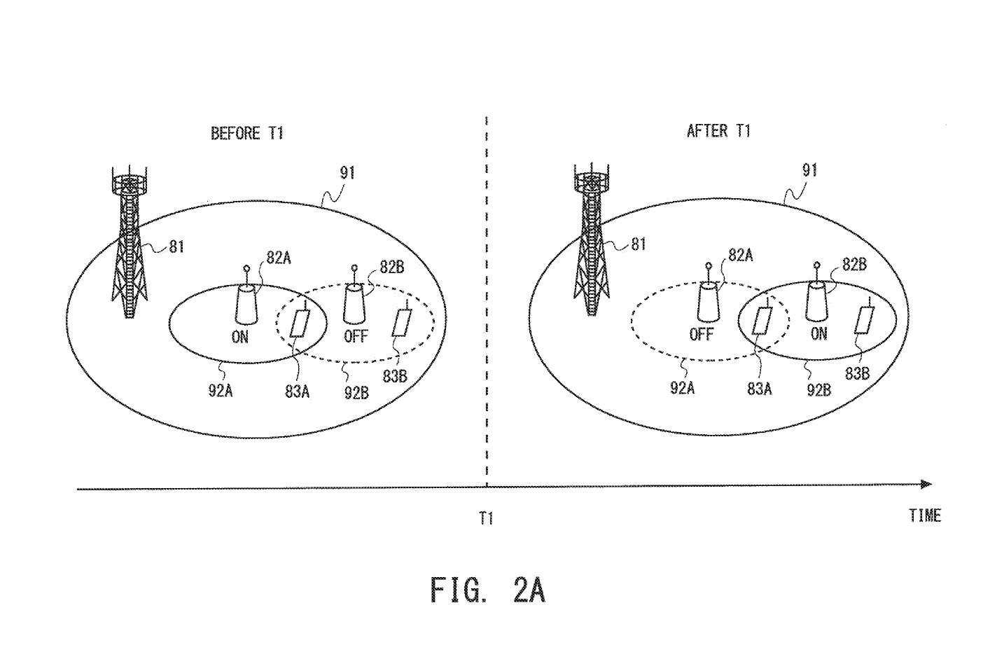

FIG. 2B is a timing diagram illustrating an operation of a communication system relating to turning on a small cell.

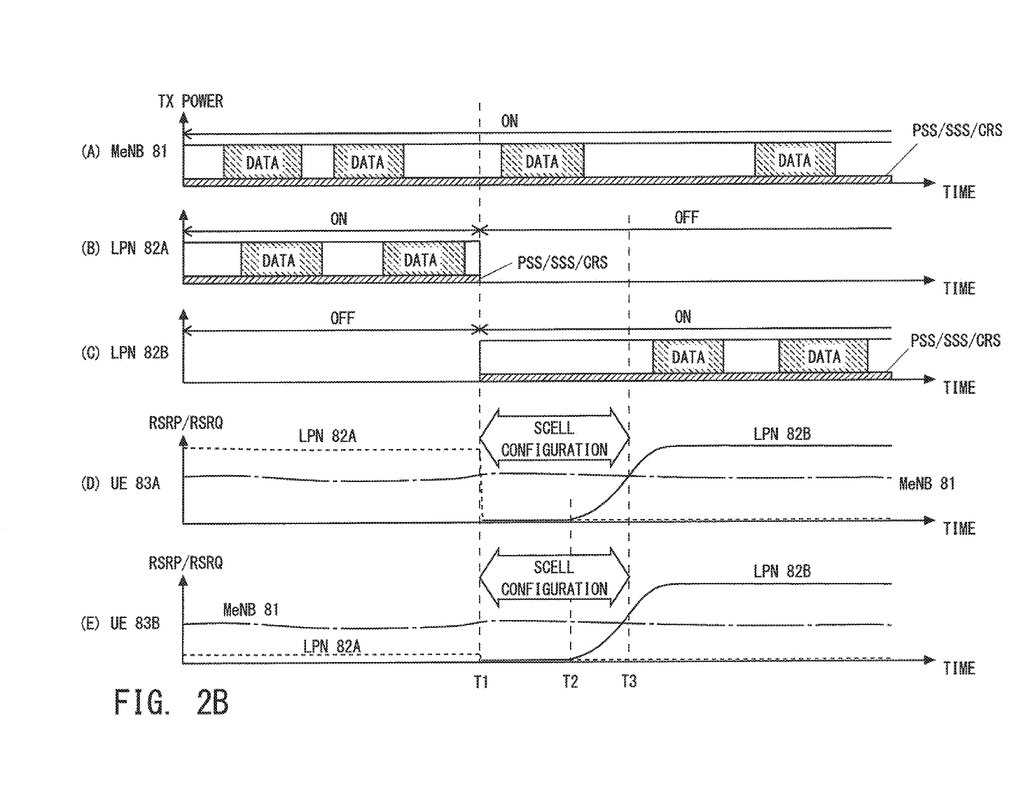

FIG. 3 is a timing diagram illustrating an operation of a communication system relating to turning on a small cell.

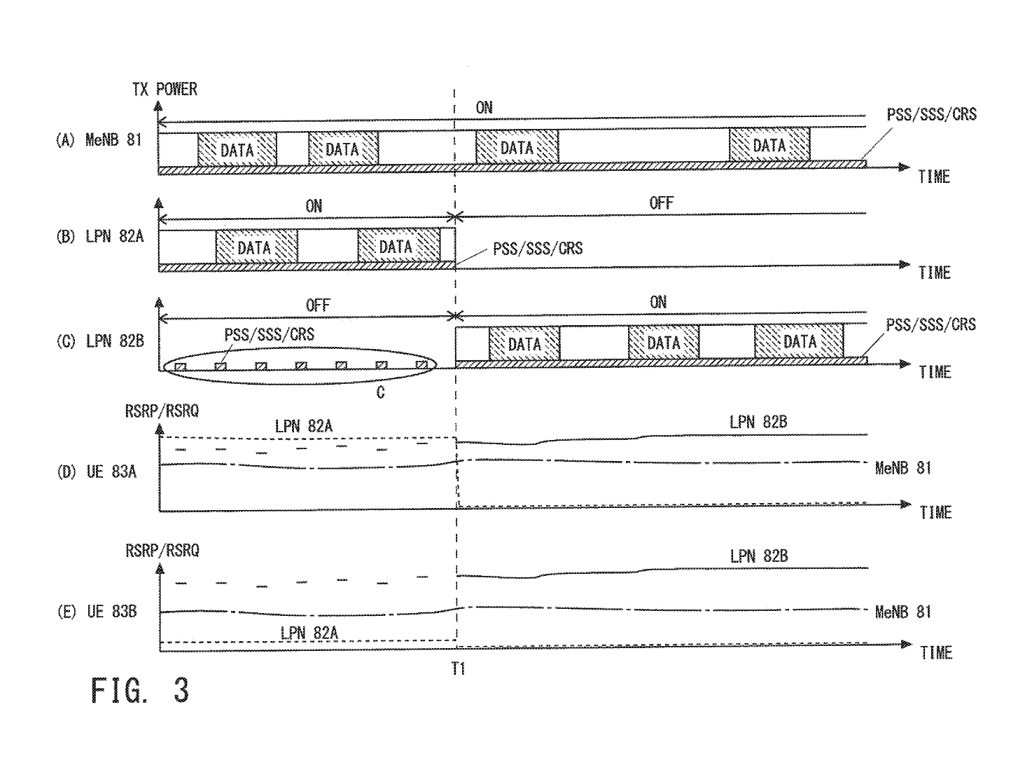

FIG. 4 is a block diagram illustrating an example of a communication system according to one embodiment.

FIG. 5A is a diagram conceptually illustrating a small cell ON/OFF behavior of a low power node according to one embodiment.

FIG. 5B is a timing diagram illustrating an operation of a communication system relating to turning on a small cell in one embodiment.

FIG. 6 is a sequence diagram illustrating an example procedure for turning on a small cell in one embodiment.

FIG. 7A is a timing diagram illustrating an operation of a communication system relating to adjusting a length of a Discovery Period in one embodiment.

FIG. 7B is a timing diagram illustrating an operation of a communication system relating to adjusting a length of a Discovery Period in one embodiment.

FIG. 8A is a diagram conceptually illustrating a small cell ON/OFF behavior of a low power node according to one embodiment.

FIG. 8B is a timing diagram illustrating an operation of a communication system relating to turning on a small cell in one embodiment.

FIG. 9 is a sequence diagram illustrating an example procedure for turning on a small cell in one embodiment.

FIG. 10A is a diagram conceptually illustrating a small cell ON/OFF behavior of a low power node according to one embodiment.

FIG. 10B is a timing diagram illustrating an operation of a communication system relating to turning on a small cell in one embodiment.

FIG. 11 is a flow chart illustrating an operation example of macro eNodeB in one embodiment.

FIG. 12 is a sequence diagram illustrating an example procedure for turning on a small cell in one embodiment.

FIG. 13 is a timing diagram illustrating an operation of a communication system relating to turning on a small cell in one embodiment.

### DESCRIPTION OF EMBODIMENTS

The preferred embodiments of the present invention will be explained by making references to the accompanied drawings. The embodiments used to describe the principles of the present disclosure are by way of illustration only and should not be construed in any way to limit the scope of the disclosure. Those skilled in the art will understand that the principles of the present disclosure may be implemented in any suitably arranged wireless network. In this technical area, a cell, a node, an eNB and a component carrier may have same meaning, and a primary cell (PCell) and a secondary cell (SCell) can also be interpreted as a master eNB and a secondary eNB (SeNB), respectively.

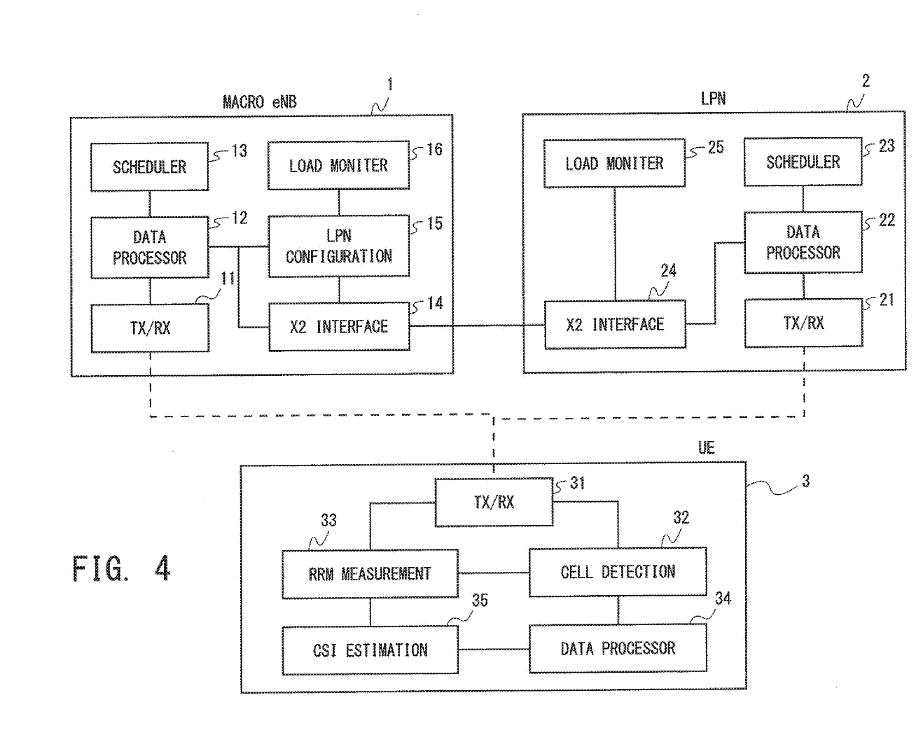

FIG. 4 illustrates a configuration example of a wireless communication system which will be used to describe the following exemplary embodiments. By way of example and without limitation, the aspects of the present disclosure illustrated in FIG. 4 are presented with reference to an LTE or LTE-Advanced system. In this example, the LTE or LTE-Advanced system includes a MeNB 1, an LPN 2 and a UE 3.

The MeNB 1 may include a transceiver 11, a data processor 12, a scheduler 13, an X2 interface 14, an LPN configuration unit 15, and a load monitor 16. The transceiver 11 provides various signal conditioning functions including amplifying and modulating for downlink transmission to the UE 3 and amplifying and de-modulating for uplink reception from the UE 3.

The data processor 12 generates a transport channel, according to scheduling by the scheduler 13, by performing error correction encoding, rate matching, interleaving, and the like. Further, the data processor 12 generates a radio frame by adding control information from the scheduler 13 and the LPN configuration unit 15 to the data sequence of the transport channel to generate a radio frame. Furthermore, the data processor 12 generates a transmission symbol sequence for each physical channel by performing scrambling and modulation symbol mapping based on various modulation schemes for the data sequence of the radio frame. The data processor 12 also restores received data from a reception symbol sequence supplied from the transceiver 11. Control information included in the obtained received data is transferred to the scheduler 13, the X2 interface 14, or the LPN configuration unit 15.

The X2 interface 14 provides communication function with other base stations including the LPN 2. The LPN configuration unit 15 sends and receives control signals to and from the LPN 2, via the X2 interface 14, for adding, deleting or modifying SCell for the UE 3. In one embodiment, the LPN configuration unit 15 may send to the LPN 2 a control signal including configuration information indicating at least one of the information of a starting time and a length of a discovery period applied on the LPN 2. Details of the discovery period are described later. In one embodiment, the LPN configuration unit 15 may also determine timing when the LPN 2 is being turned on (i.e., the starting time of the ON period) and instruct the LPN 2 to turn on.

The load monitor 16 monitors traffic load of the MeNB 1. The traffic load of the MeNB 1 may be used by the LPN configuration unit 15 for determining the starting time or the length of the discovery period applied on the LPN 2 or determining the timing when the LPN 2 is being turned on.

The LPN 2 may include a transceiver 21, a data processor 22, a scheduler 23, an X2 interface 24, and a load monitor 25. The transceiver 21, the data processor 22, the scheduler 23, and the X2 interface 24 have similar functions to those of the transceiver 11, the data processor 12, the scheduler 13, and the X2 interface 14 of the MeNB 1, respectively.

The load monitor 25 monitors traffic load of the LPN 2. The traffic load of the LPN 2 may be sent to the LPN configuration unit 15 via the X2 interface 24, and may be used by the LPN configuration unit 15 for determining the starting time or the length of the discovery period applied on other LPN or determining the timing when other LPN is being turned on.

The UE 3 may include a transceiver 31, a cell detection unit 32, RRM measurement unit 33, a data processor 34, and a channel-state-information (CSI) estimation unit 35. The transceiver 31 communicates with the Macro eNB 1 and the LPN 2 via an air interface. The transceiver 11 provides various signal conditioning functions including amplifying and modulating for uplink transmission to the MeNB 1 and the LPN 2 and amplifying and de-modulating for downlink reception from the MeNB 1 and the LPN 2.

The cell detection unit 32 performs a cell detection procedure. The cell detection procedure includes a cell search to detect the Cell ID and acquire frame synchronization of that cell based on sounding the PSS (i.e., primary synchronization channel (P-SCH)) and the SSS (i.e., secondary synchronization channel (S-SCH)). The cell detection procedure also includes acquisition of the system information based on demodulating the PBCH.

The RRM measurement unit 33 performs RRM measurement over the CRSs to measure the either or both RSRP and RSRQ from intra-frequency cells and inter-frequency cells.

The data processor 34 generates a transport channel, according to scheduling by the scheduler 13 at the MeNB 1, by performing error correction encoding, rate matching, interleaving, and the like. Further, the data processor 34 generates a radio frame by adding control information to the data sequence of the transport channel to generate a radio frame. Furthermore, the data processor 34 generates a transmission symbol sequence for each physical channel by performing scrambling and modulation symbol mapping based on various modulation schemes for the data sequence of the radio frame. The data processor 34 also restores received data from a reception symbol sequence supplied from the transceiver 31.

The CSI estimation unit 35 performs channel estimation in order to determine the phase reference for demodulating downlink control channels and downlink data based on monitoring the CRSs.

### First Embodiment

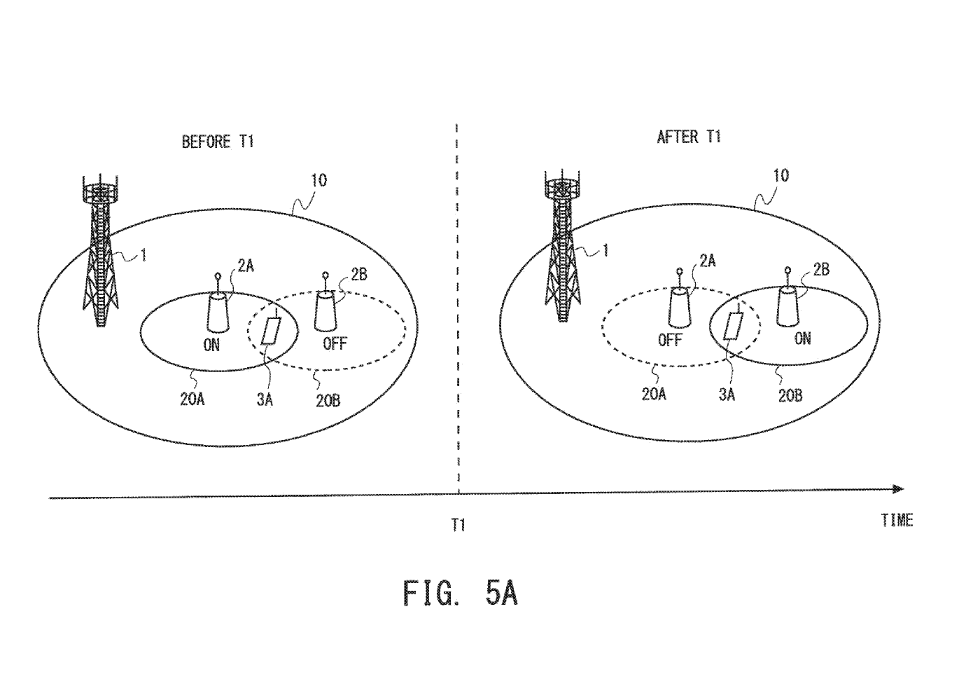

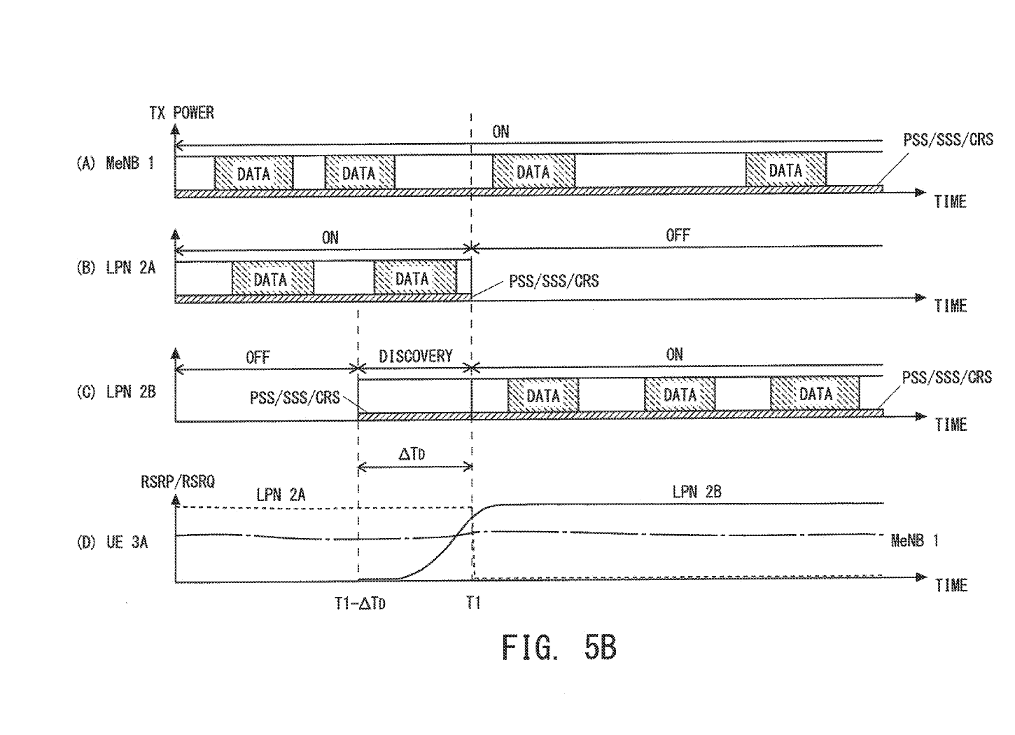

FIG. 5A conceptually illustrates an example of small cell ON/OFF behavior of the LPN 2 according to a first embodiment, where a network has already semi-statically configured the time T1 when the LPN 2A is being turned from ON to OFF and the LPN 2B is being turned from OFF to ON for user data transmission/reception. FIG. 5B shows a timing diagram illustrating operations of the MeNB 1, the LPNs 2A and 2B, and the UE 3A corresponding to FIG. 5A. The UE 3A in FIGS. 5A and 5B is in RRC_CONNECTED mode with the macro cell 10, controlled by the MeNB 1, as PCell and also served by the small cell 20A, controlled by the LPN 2A, as SCell during the ON period of the LPN 2A.

The Network configures the length DELTA.T_{D} of the discovery period for the LPN 2B before the time T1. Note that, in drawings, “DELTA.” is denoted by the Greek letter delta. The discovery period is defined as a previous time period adjacent to the ON period. In other words, the discovery period immediately follows the OFF period and is immediately followed by the ON period. During the discovery period, the LPN 2B sends the signals necessary for cell detection and RRM measurement but does not sends data signals for user data transmission and reception with the UE 3A. The length DELTA.T_{D} of the discovery period may be configured so as to ensure that legacy UEs until LTE Release 11 can perform cell detection and RRM measurement for the LPN 2B sufficiently and accurately. The network, which configures the length DELTA.T_{D} applied on the LPN 2B, may include at least one of the MeNB 1, an LPN gateway (not shown), and an Operation, Administration, and Maintenance (OAM) system (not shown). The LPN gateway aggregates plurality of the LPNs 2 and connects them to a core network.

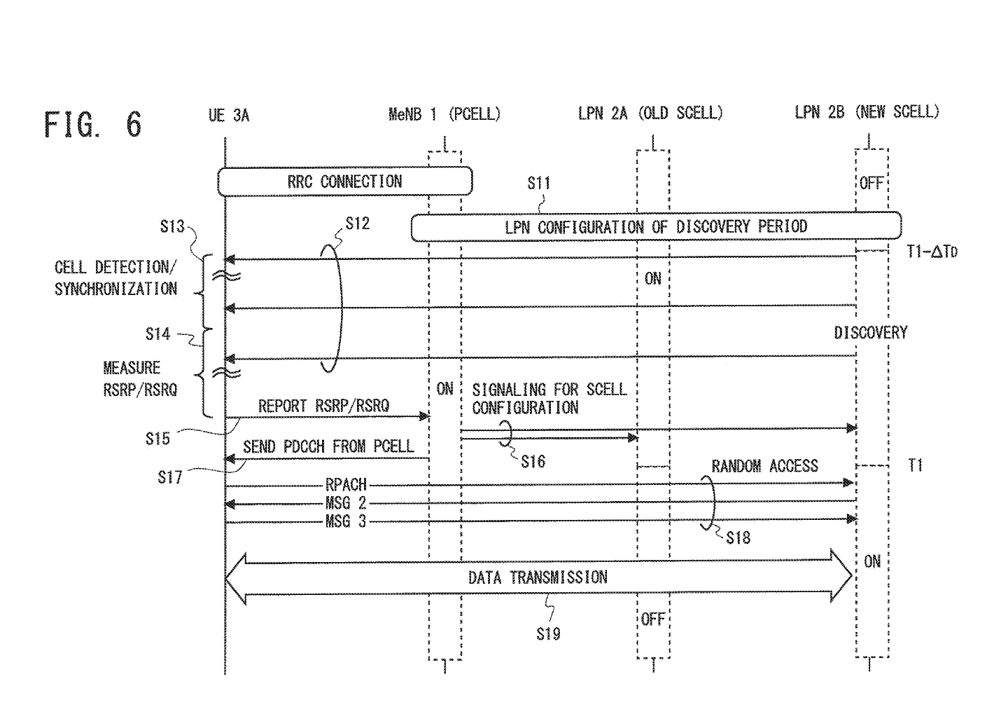

Returning to FIGS. 5A and 5B, from the time of (T1-DELTA.T_{D}), i.e., the starting time of the discovery period, the LPN 2B starts to send the signals necessary for cell detection and RRM measurement, such as PSS/SSS, PBCH and CRS. During the Discovery period, UE 3A can detect the LPN 2B and report the RRM measurement results of LPN 2B by using the legacy UE behavior. With the knowledge of the reported RRM measurement results of LPN 2B, the MeNB 1 can release the conventional SCell of LPN 2A and configure the new SCell of LPN 2B for UE 3A. The detailed procedure is described as follows by using the illustrated structure in FIG. 4 and the related signaling procedure in FIG. 6.

As shown as step S11 in FIG. 6, the MeNB 1 configures the discovery period of DELTA.T_{D} from the time of (T1-DELTA.T_{D}) for the LPN 2B in the LPN configuration unit 15. The MeNB 1 informs the LPN 2B about the configured information of the discovery period through the X2 interface 14. Thereafter, in step S12 of FIG. 6, the LPN 2B prepares the signals for cell detection and RRM measurement in the data processor 22 and sends the signals from the time of (T1-DELTA.T_{D}) to the time T1 by the transceiver 21.

At the UE 3A, the UE 3A carries out step S13 of FIG. 6 and search the LPN 2B by detecting its PSS/SSS received by the transceiver 31 during the discovery period, to identify the cell physical ID and achieve the time synchronization in the Cell detection unit 32. After that, the data processor 34 receives the PBCH to obtain the system information of the LPN 2B by using the channel estimation results based on the CRS in the CSI estimation unit 35. Next, in step S14 of FIG. 6, the RRM measurement unit 33 measures either or both RSRP and RSRQ by detecting the CRS of the LPN 2B sent during the discovery period. As step S15 of FIG. 6, the UE 3A reports the measured RSRP/RSRQ to the MeNB 1 through the transceiver 31 in FIG. 4.

At the MeNB 1, the reported RRM measurement results (i.e., the measured RSRP/RSRQ) are received by the transceiver 11 and compared in the LPN configuration unit 15. After finding the RSRP/RSRQ of the LPN 2B is highest for the UE 3A, the MeNB 1 carries out step S16 of FIG. 6 and sends signals through the X2 interface 14 to the LPN 2B to let the LPN 2B as new SCell for the UE 3A from the time T1. The MeNB 1 also sends signals to the LPN 2A to release the conventional SCell for the UE 3A from the time T1. At the same time, the MeNB 1 generates a physical downlink control channel (PDCCH) in the data processor 12 in FIG. 4 based on the results of the scheduler 13 and then sends the PDCCH to the UE 3A in step S17 of FIG. 6, where the PDCCH includes allocated resource information for the UE 3A to send a physical random access channel (PRACH).

In step S18 of FIG. 6, the UE 3A initiates a random access procedure in order to access the LPN 2B. Based on the PDCCH from the MeNB 1, the UE 3A generates the PRACH including a random access preamble (Message 1) in the data processor 34 and sends the PRACH from the transceiver 31 of FIG. 4. When the LPN 2B identifies the PRACH from the UE 3A, the remaining process of the step S18, such as sending a random access response (Message2) from the small cell 20B (LPN 2B) to the UE 3A, and sending a Layer-2/Layer-3 message (Message 3) from the UE 3A to the small cell 20B (LPN 2B), is carried out between the UE 3A and the LPN 2B. The LPN2 becomes the new SCell of UE 3A soon after the time T1 when the LPN 2B is being turned on to send signals for data reception and/or transmission (step S19 of FIG. 6).

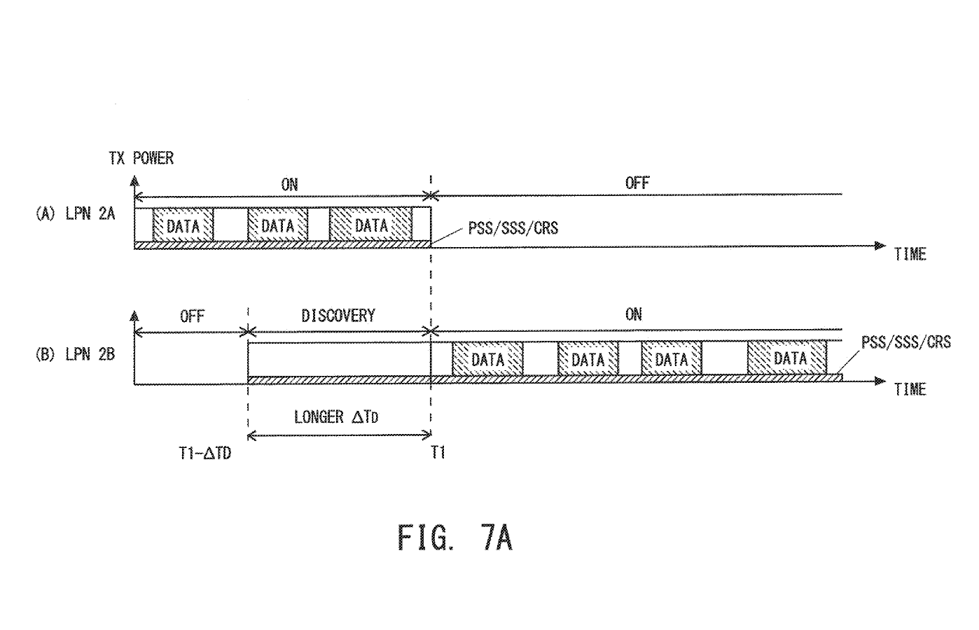

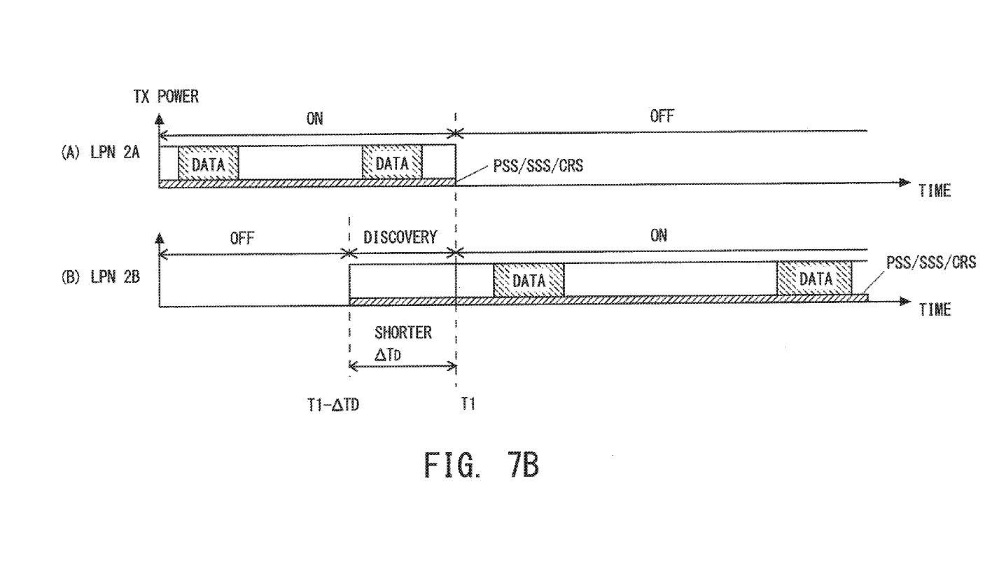

In the first embodiment, the length DELTA.T_{D} of the discovery period for the LPN 2B may be adaptively configured according to traffic load to be shifted from the LPN 2A to the LPN 2B, which is monitored in the load monitor 25 at the LPN 2A controlling the conventional SCell. The traffic load monitored at the LPN 2A is, for example, a traffic load remained in a data buffer implemented in the LPN 2A, the number of active UEs accessed in LPN 2A, or an average traffic load of the LPN 2A. FIGS. 7A and 7B illustrate timing diagrams showing different lengths of the discovery period. As illustrated in FIG. 7A, in the case of larger traffic load to be shifted from the LPN 2A to the LPN 2B, a longer discovery period (e.g., 1.0 second) may be configured for the LPN 2B for fast load shifting between the LPN 2A and the LPN 2B that use the same frequency. In contrast, in the case of smaller traffic load to be shifted from the LPN 2A to the LPN 2B as shown in FIG. 7B, a shorter discovery period (e.g., 0.5 second) may be configured for the LPN 2B to reduce the inter-cell interference between the LPN 2A and the LPN 2B during the Discovery period.

### Second Embodiment

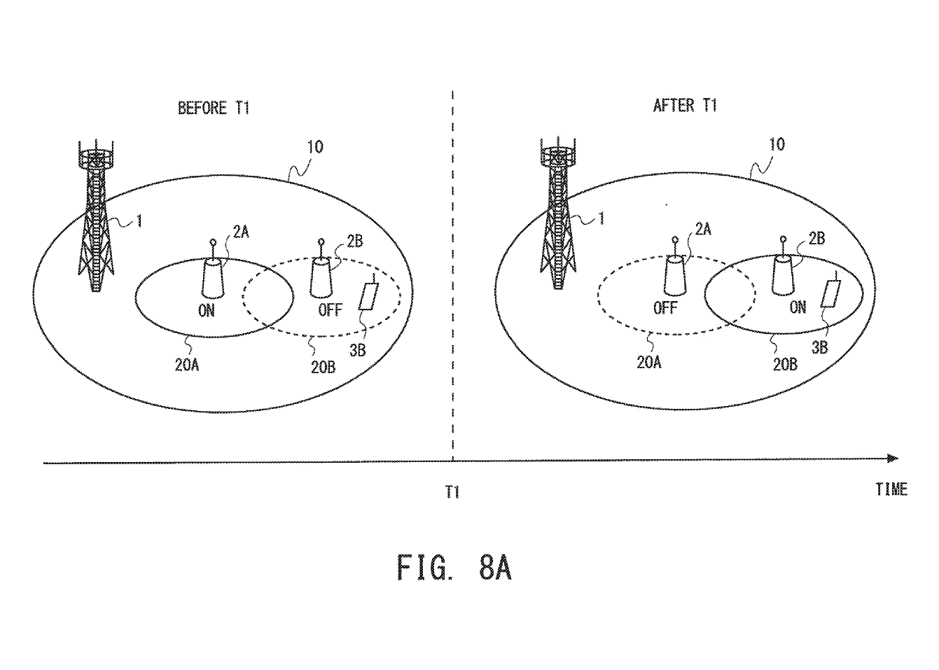

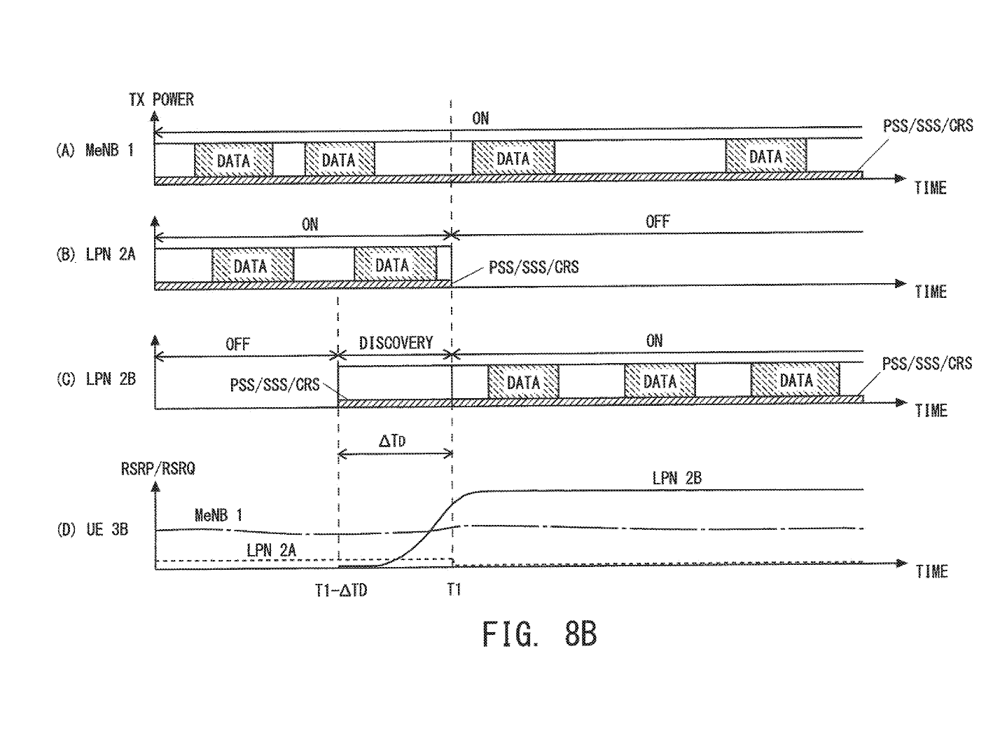

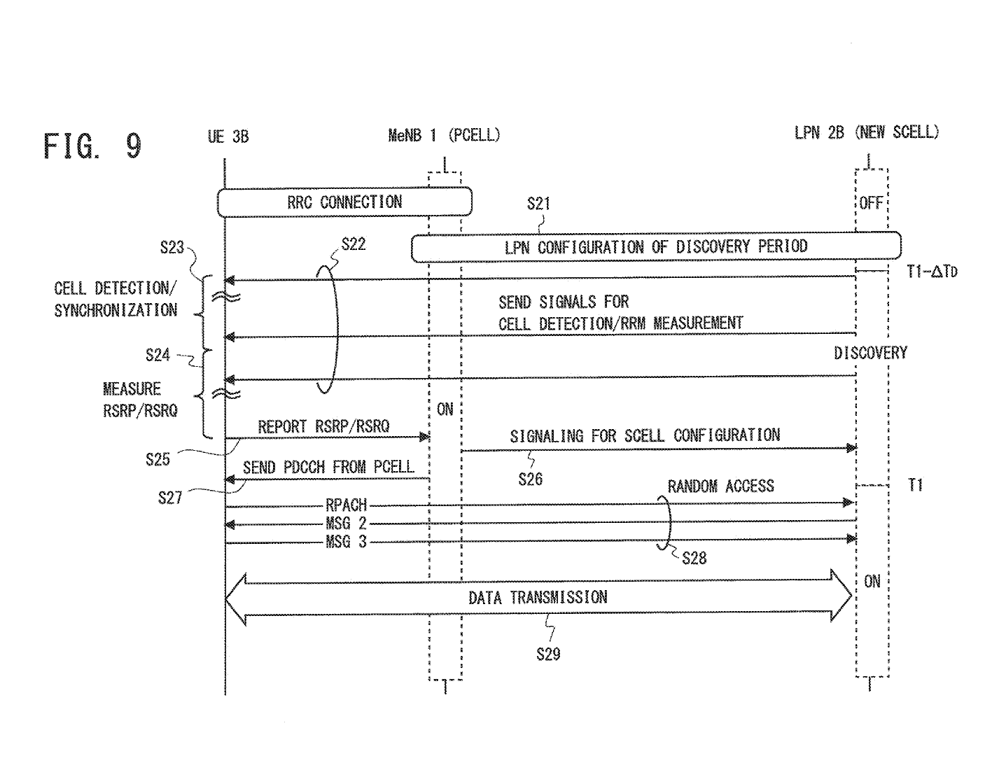

FIG. 8A conceptually illustrates an example of small cell ON/OFF behavior of the LPN 2 according to a second embodiment, where the network has already semi-statically configured the time T1 when the LPN 2A is being turned from ON to OFF and the LPN 2B is being turned from OFF to ON for user data transmission/reception. FIG. 8B shows a timing diagram illustrating operations of the MeNB 1, the LPNs 2A and 2B, and the UE 3B corresponding to FIG. 8A. The UE 3B in FIGS. 8A and 8B is inter-eNB CA-capable and in RRC_CONNECTED mode with the macro cell 10, controlled by the Macro eNB, as PCell, but no SCell for the UE 3B is configured before T1. The network configures the discovery period of DELTA.T_{D} for the LPN 2B before the time T1, which is same as that of the first embodiment. Different from UE 3A in FIGS. 5A and 5B, the UE 3B is firstly configured a SCell by the MeNB 1, and therefore the network only configure a new SCell of the LPN 2B. The detailed procedure is described as follows by using the illustrated structure in FIG. 4 and the related signaling procedure in FIG. 9.

As shown as step S21 in FIG. 9, the MeNB 1 configures the discovery period of DELTA.T_{D} from the time of (T1-DELTA.T_{D}) for the LPN 2B in the LPN configuration unit 15. The MeNB 1 informs the LPN 2B about the configured information of the discovery period through the X2 interface 14 of FIG. 4. Thereafter, in step S22 of FIG. 9, the LPN 2B prepares the signals for cell detection and RRM measurement in the data processor 22 and periodically sends the signals from the time of (T1-DELTA.T_{D}) to the time T1 by the transceiver 21.

At the UE 3B, the UE 3B carries out step S23 of FIG. 9 and search the LPN 2B by detecting its PSS/SSS received by the transceiver 31 during the discovery period, to identify the cell physical ID and achieve time synchronization in the Cell detection unit 32. After that, the data processor 34 receives the PBCH to obtain the system information of the LPN 2B by using the channel estimation results based on the CRS in the CSI estimation unit 35. Next, in step S24 of FIG. 9, the RRM measurement unit 33 measures either or both RSRP and RSRQ by detecting the CRS of the LPN 2B sent during the discovery period. As step S25 of FIG. 9, the UE 3B reports the measured RSRP/RSRQ to the MeNB 1 through the transceiver 31.

At the MeNB 1, the reported RRM measurement results (i.e., the measured RSRP/RSRQ) are received by the transceiver 11 and compared in the LPN configuration unit 15. After finding the RSRP/RSRQ of the LPN 2B is highest for the UE 3B, the MeNB 1 carries out step S26 of FIG. 9 and sends signals through the X2 interface 14 to the LPN 2B to let the LPN 2B as new SCell for the UE 3B from the time T1. At the same time, the MeNB 1 generates a PDCCH in the data processor 12 based on the results of the scheduler 13 and then sends the PDCCH to the UE 3B through the transceiver 11 in step S27 of FIG. 9, where the PDCCH includes allocated resource information for the UE 3B to send a PRACH.

In step S28 of FIG. 9, the UE 3B initiates a random access procedure in order to access the LPN 2B. In step S29 of FIG. 9, UE 3B performs data transmission and/or reception with the SCell of the LPN 2B soon after the time T1 when LPN 2B is being turned on. The operations at the steps S28 and S29 of FIG. 9 are the same as those of the steps S18 and S19 of FIG. 6 described in the first embodiment, so the detailed description thereof is omitted.

In the second embodiment, the length DELTA.T_{D} of the discovery period for the LPN 2B may be configured according to relationship between the carrier frequencies of the MeNB 1 and the LPN 2B. In the case where the MeNB 1 and the LPN 2B use different carrier frequencies, a longer discovery period (e.g., from 2-4 seconds) may be configured for the LPN 2B for inter-frequency cell detection/RRM measurement. In the case where the MeNB 1 and the LPN 2B use the same carrier frequency, a shorter discovery period (e.g., 0.5-1 second) may be configured for the LPN 2B for intra-frequency cell detection/RRM measurement.

### Third Embodiment

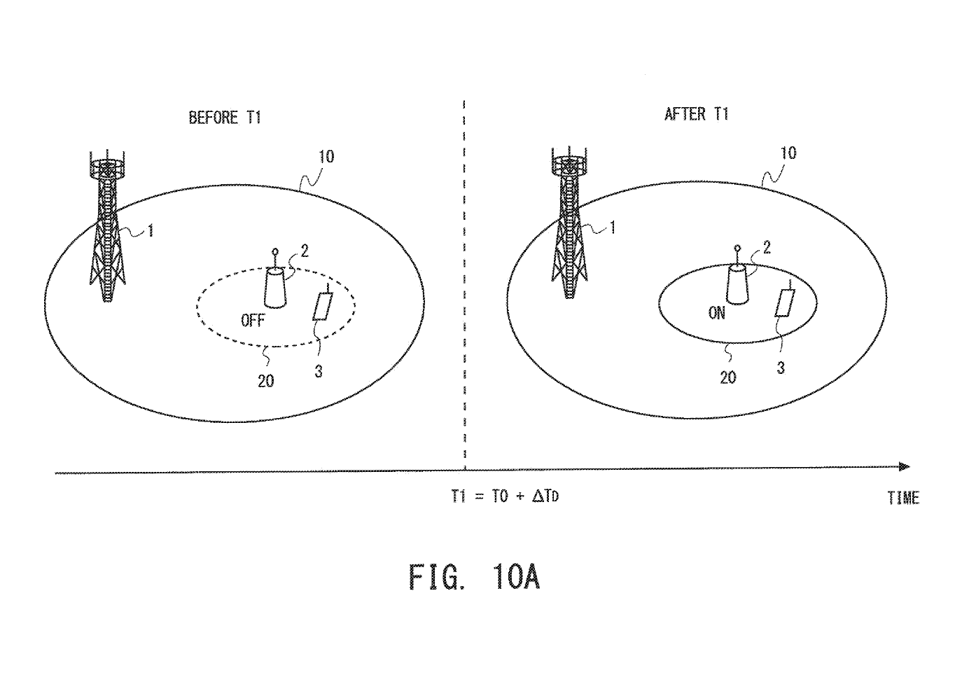

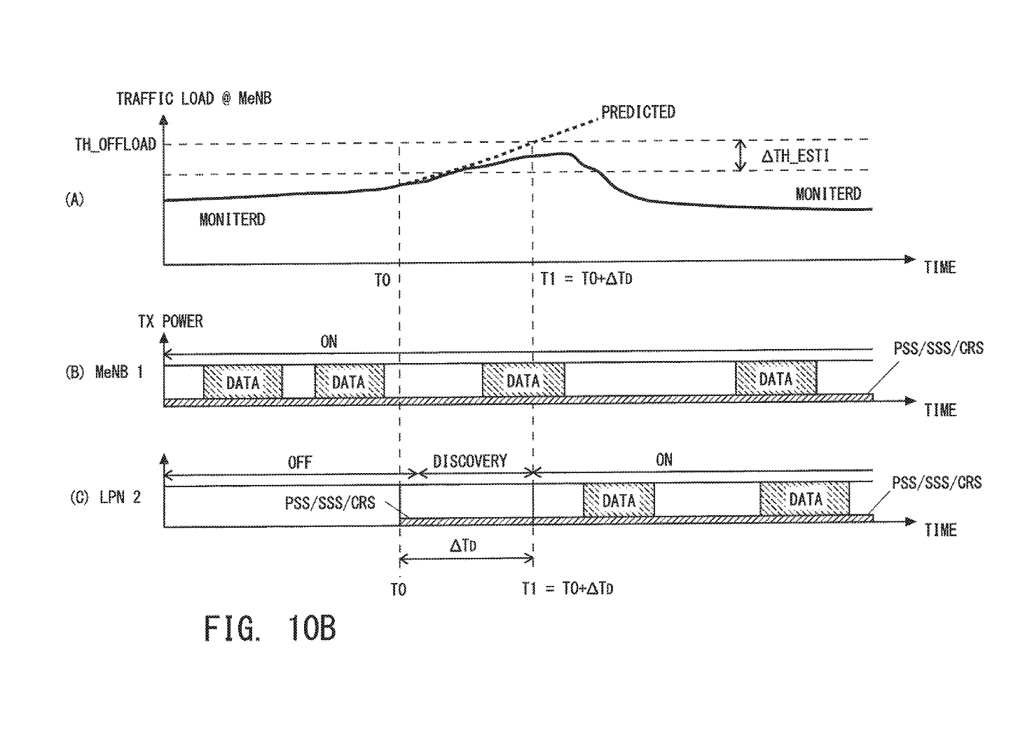

This embodiment illustrates a modification of the above-mentioned first and second embodiments. FIG. 10A conceptually illustrates an example of small cell ON/OFF behavior of the LPN 2 according to the third embodiment, where the network dynamically decided the time T1 when the LPN 2 is being turned from OFF to ON for user data transmission/reception. FIG. 10B shows a timing diagram illustrating operations of the MeNB 1 and the LPN 2 corresponding to FIG. 10A. The network may decide to turn on the LPN 2 based on, for example, traffic load at the MeNB 1, or traffic load at an LPN(s) adjacent to the LPN 2. The network, which dynamically decides the time T1 applied on the LPN 2, may include at least one of the MeNB 1, an LPN gateway (not shown), and an OAM system (not shown).

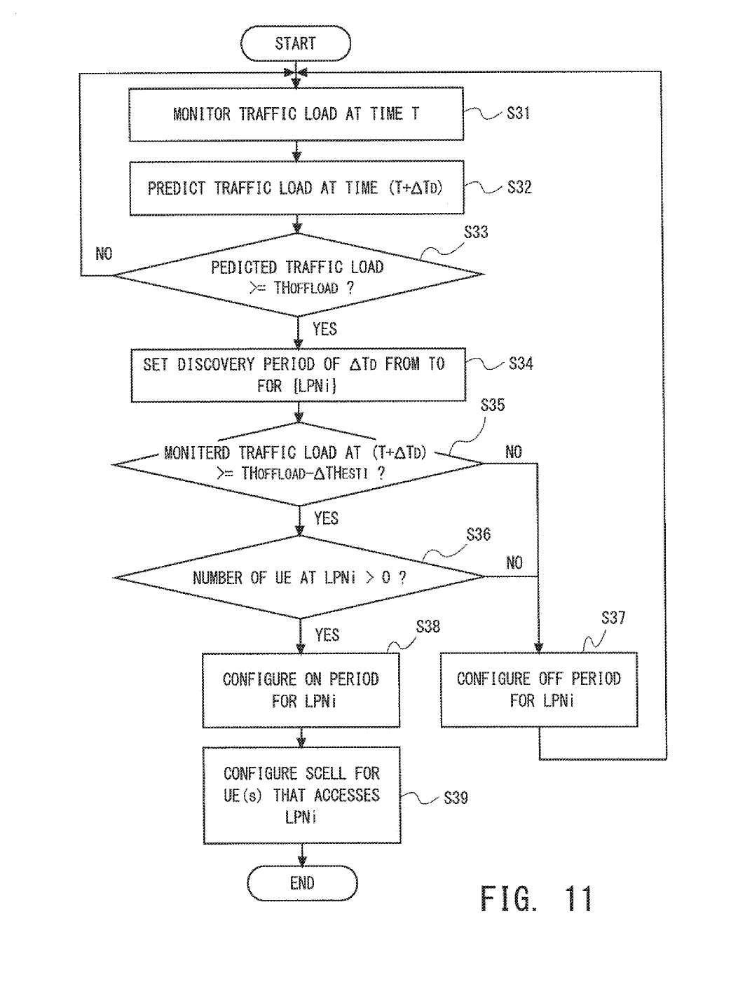

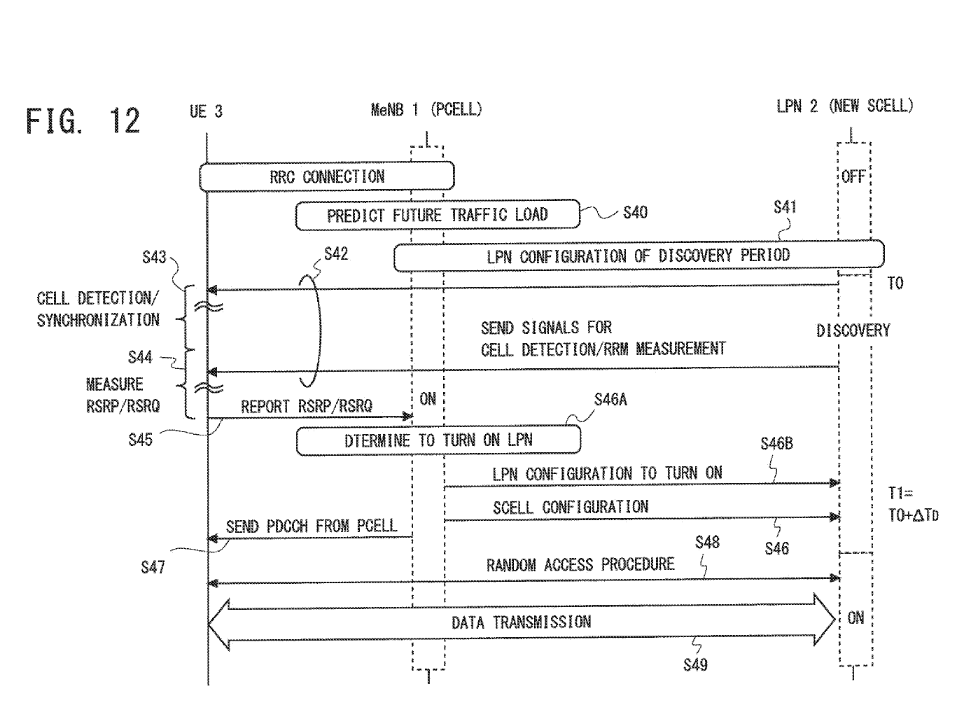

Returning to FIGS. 10A and 10B, the time T1 is defined as T1=T0+DELTA.T_{D} by assuming the configured discovery period of DELTA.T_{D} and the time T0 that is the starting time of the discovery period. How to decide the time T0 is described in the following by using the illustrated structure in FIG. 4, the flowchart for the MeNB 1 in FIG. 11 and the related signaling procedure in FIG. 12.

FIG. 11 shows a flow chart illustrating an operation example of the MeNB 1. In step S31, the MeNB 1 timely monitors its traffic load at the load monitor 16 in FIG. 4. In step S32, the MeNB 1 predicts future traffic load at a time after the period DELTA.T_{D} (i.e., at the time of T+DELTA.T_{D}) in the LPN configuration unit 15, where DELTA.T_{D} is predefined length of the discovery period for candidate LPNs {LPNi}. The candidate LPNs {LPNi} includes at least one LPN 2 located within the macro cell 10. If the predicted traffic load at the time of T+DELTA.T_{D} is larger than a predefined threshold, TH_{offload}, the time T is regarded as the time T0, which is the decided starting time of the discovery period for LPNi.

In step S34, the MeNB 1 sends the signals to the candidate LPNs {LPNi} to set the discovery period of DELTA.T_{D} from T0. After the discovery period, in step S35, the MeNB 1 needs to compare the monitored traffic load at T1=T0+DELTA.T_{D} with the predefined threshold TH_{offload}-DELTA.THₑₛₜᵢ, where DELTA.THₑₛₜᵢ is the limitation of estimation error. If the practically monitored traffic load at the time T1 is not larger than TH_{offload}-DELTA.THₑₛₜᵢ (NO in step S35), the MeNB 1 configures OFF period for the candidate LPNs {LPNi} in step S37. Otherwise, in step S36, the MeNB 1 further checks the number of the UEs to be accessed to each LPNi.

If the number of UEs at LPNi is larger than 0 (YES in step S36), the MeNB 1 configures ON period for the LPNi after the time T1 (steps S38 and S39). Otherwise, the MeNB 1 configures OFF period for the LPNi to save the power consumption (step S37).

FIG. 12 shows an example procedure in the case that the LPN 2 is dynamically turned on for load shifting from the MeNB 1. In step S40, the MeNB 1 monitors its current traffic load, and predicts a timing that the traffic load of the MeNB 1 reaches the threshold TH_{offload}. When the predicted traffic load at T1=T0+DELTA.T_{D} is larger than TH_{offload}, the signaling procedure among the MeNB 1, the LPN 2 and the UE 3 is carried out in steps S41 to S45, as similar to the steps S21 to S25 of FIG. 9. The steps S41 to S45 includes (a) sending the configuration information indicating the configured discovery period to the LPN 2 from the MeNB 1, (b) sending, by the LPN 2, signals for cell detection and RRM measurement during the discovery period, and (c) performing, by the UE 3, cell detection and RRM measurement/reporting based on the signals from the LPN 2 during the discovery period. After that, in step S46A, the MeNB 1 finds out that the monitored traffic load at T1=T0+DELTA.T_{D} is larger than TH_{offload}-DELTA.THₑₛₜᵢ. In step S46B, the MeNB turns on the LPN which has at least one UE to be accessed. If the LPN 2 is being turned on, the steps S46 to S49 are carried out in the same way as the steps S26 to S28 of FIG. 9 for SCell configuration and UE random access.

### Fourth Embodiment

The above first to third embodiments illustrate how to configure the starting time T1 and/or the length DELTA.T of the discovery period. The fourth embodiment shows some examples to configure parameters of the signals sent during the discovery period. The same assumption of the first embodiment is used in the fourth embodiment for illustration, where the network has already semi-statically configured the time T1 when the LPN 2A is being turned from ON to OFF and the LPN 2B is being turned from OFF to ON for user data transmission/reception. The UE 3 in this embodiment is in RRC_CONNECTED mode with the MeNB 1 as PCell and also served by LPN 2A as SCell during the ON period of the LPN 2A. The discovery period of DELTA.T_{D} is configured before the LPN 2B is turned on. In order to reduce interference from the LPN 2B to the MeNB 1 or the LPN 2A during the discovery period, which is overlapped with the ON period of the source cell LPN1, the LPN 2B reduces the transmission power of the signals necessary for cell detection and RRM measurement, such as PSS/SSS, PBCH and CRS, during the discovery period.

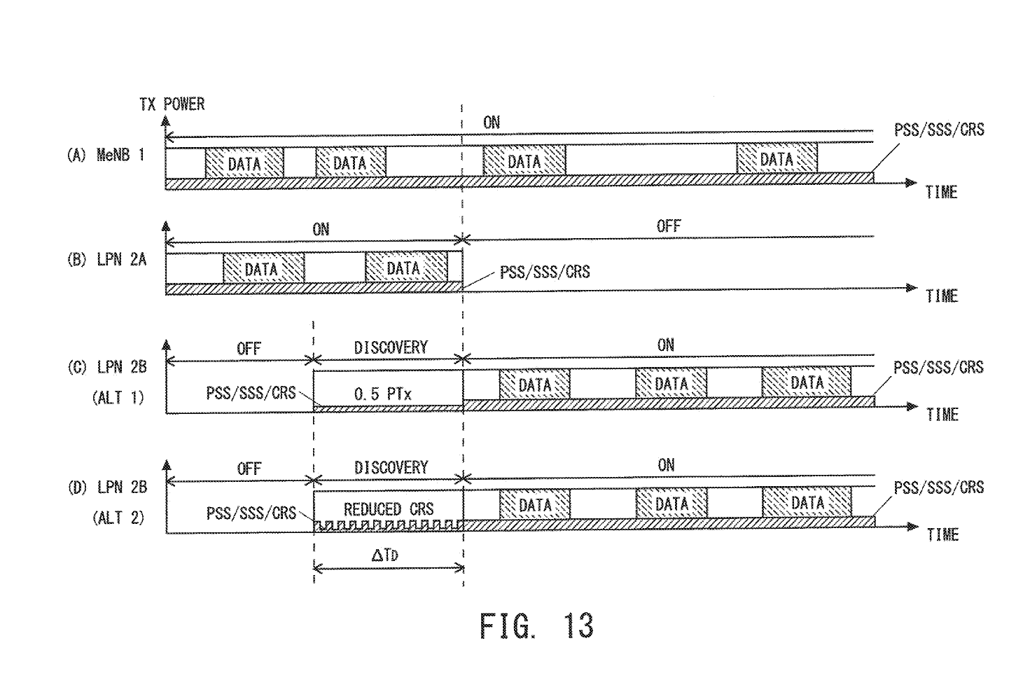

FIG. 13 illustrates operations of the MeNB 1, the LPN 2A, and the LPN 2B. In Alternative 1 (Alt1) shown in FIG. 13, the network configures the LPN 2B to reduce the transmit power during the discovery period, for example, by 50% from the power Ptx at the ON period (i.e., 0.5 Ptx). The interference from the LPN 2B to the LPN 2A is reduced accordingly. The transmission power of the LPN 2B during the discovery period may be set by the LPN configuration unit 15 in the MeNB 1. To be specific, the power of all the resource blocks in the frequency-domain is reduced; or only the power of half the resource blocks in the frequency-domain is used. In Alternative 2 (Alt2) shown in FIG. 13, the reduced CRS with larger (i.e., finer or more frequent) periodicity, e.g., CRS sent in every 5 milliseconds, is used during the discovery period. It can also reduce the interference from the LPN 2B to the LPN 2A. The periodicity of the CRS during the discovery period may be set by the LPN configuration unit 15 in the MeNB 1.

### Other Embodiments

The start time T1 of the discovery period may be informed to the UE 3 in the first to fourth embodiments. It is more efficient for the UE 3 to detect the LPN 2 during the discovery period because the UE 3 does not need to keep searching the LPN 2 in the OFF period.

Besides PSS/SSS, PBCH and CRS, other existing LTE signals, such as a Positioning Reference Signal (PRS) and a channel state information reference signal (CSI-RS), may also be used as the signals for cell detection and RRM measurements.

The above embodiments can be combined as appropriate.

The function of the LPN configuration unit 15 described in the above embodiments may be arranged in an apparatus different from the MeNB 1. For example, the LPN configuration unit 15 may be arranged in an LPN gateway or an OAM system.

The above embodiments have described the cases where the present disclosure is applied to LTE or LTE-Advanced systems. However, the application of the present disclosure is not limited to LTE or LTE-Advanced systems. Specifically, the present disclosure is also applicable to the case of a heterogeneous network including a large cell and at least one small cell that is located within the large cell and is capable of being turned on and off.

The LPN configuration unit 15 of the MeNB 1 explained above may be implemented by semiconductor processing devices, such as an application specific integrated circuit (ASIC) or a digital signal processor (DSP). Alternatively, the LPN configuration unit 15 may be implemented by causing a computer system including a processor such as a central processing unit (CPU) and a micro processing unit (MPU) to execute one or more programs. However, a part or the functions of the LPN configuration unit 15 may be also configured by hardware.

The processes performed by the LPN 2 and the UE 3 with respect to the procedures for turning on the small cell 20 may also be implemented by semiconductor processing devices, such as an ASIC or a DSP. Alternatively, these processes may be implemented by software, i.e., by causing a computer system to execute one or more programs.

These programs can be stored in various types of non-transitory computer-readable media and then provided to a computer. Such non-transitory computer-readable media include various types of tangible storage media, for example, magnetic storage media (e.g. flexible disks, magnetic tapes, hard disk drives), magneto-optical storage media (e.g. magneto-optical disks), compact disc read-only memories (CD-ROMs), CD-Rs, CD-R/Ws, semiconductor memories (e.g. mask ROMs, programmable ROMs (PROMs), erasable PROMs (EPROMs), flash ROMs, and random access memories (RAMs). Alternatively, the program may be provided to a computer through various types of transitory computer-readable media. Examples of the transitory computer-readable media include electric signals, optical signals, and electromagnetic waves. Transitory computer-readable media can provide the program to a computer through a wired communication line, such as electric wires or optical fibers, or through a wireless communication line.

While the foregoing disclosure discusses illustrative embodiments, it should be noted that various changes and modifications could be made herein without departing from the scope of the described embodiments as defined by the appended claims. Furthermore, although elements of the above embodiments may be described or claimed in the singular, the plural is contemplated unless limitation to the singular is explicitly stated. Additionally, all or a portion of any embodiment may be utilized with all or a portion of any other embodiments, unless stated otherwise.

### REFERENCE SIGNS LIST

1 Macro eNodeB
2, 2A, 2B Low power node
3, 3A, 3B User equipment
10 Macro cell
15 LPN configuration unit
20, 20A, 20B Small cell

1. A wireless communication system comprising:
a network; and
a first node being coupled to the network and being configured to control first cell to communicate with a user equipment, wherein
the network is configured to set a discovery period in which the first node transmits a first signal necessary for cell detection and radio measurement performed by the user equipment before the first cell is turned on to transmit a second signal carrying user data for data communication between the first node and the user equipment.

2. The wireless communication system according to claim 1, wherein the discovery period is a time period adjacent to an ON period in which the first node is allowed to transmit both the first signal and the second signal.

3. The wireless communication system according to claim 2, wherein the discovery period immediately follows an OFF period and is immediately followed by the ON period, wherein the OFF period is a time period in which the first node transmits neither the first signal nor the second signal.

4. The wireless communication system according to claim 1, wherein during the discovery period, the first node is not allowed to transmit the second signal.

5. The wireless communication system according to claim 1, wherein the first signal includes at least one of a primary synchronization signal (PSS), a secondary synchronization signal (SSS), a cell-specific reference signal (CRS), a Positioning Reference Signal (PRS), and a channel state information reference signal (CSI-RS).

6. The wireless communication system according to claim 1, wherein the network sends configuration information of the discovery period to the first node.

7. The wireless communication system according to claim 6, wherein the configuration information indicates at least one of the information of a starting time and a length of the discovery period.

8. The wireless communication system according to claim 1, wherein the network adjusts a length of the discovery period applied to the first cell based on traffic load of a second cell controlled by a second node different from the first node.

9. The wireless communication system according to claim 8, wherein the network reduces the length of the discovery period with decreasing the traffic load.

10. The wireless communication system according to claim 1, wherein the network adjusts a length of the discovery period applied to the first cell depending on carrier frequencies of the first cell and a second cell controlled by a second node different from the first node.

11. The wireless communication system according to claim 10, wherein when the first cell and the second cell use different carrier frequencies, the length of the discovery period is longer than that when the first cell and the second cell use the same carrier frequency.

12. The wireless communication system according to claim 1, wherein during the discovery period, the network sends to the first node a signal to configure the first node as a secondary serving cell in carrier aggregation for the user equipment.

13. The wireless communication system according to claim 12, wherein
the network includes a third node configured to control a third cell, and
during the discovery period, the third node transmits, to the user equipment via the third cell, a signal indicating a radio resource of the first cell allocated for the user equipment, wherein the radio resource is used for transmitting a message from the user equipment to the first node during an ON period in which the first node is allowed to transmit both the first signal and the second signal.

14. The wireless communication system according to claim 1, wherein the network transmits a signal to inform the user equipment of configuration information indicating a starting time of the discovery period.

15. The wireless communication system according to claim 1, wherein
the network includes a macro base station that controls a macro cell, and
the first node and the first cell are located within the macro cell.

16. The wireless communication system according to claim 15, wherein the macro base station sends configuration information of the discovery period to the first node.

17. The wireless communication system according to claim 15, wherein the first node is a low power node.

18. The wireless communication system according to claim 1, wherein the network decides whether to start the discovery period at the first cell or not based on a traffic load of a fourth cell controlled by a fourth node different from the first node.

19. The wireless communication system according to claim 18, wherein after starting and during the discovery period, the network decides whether to start an ON period in which the first node is allowed to transmit both the first signal and the second signal, based on a traffic load of the fourth cell.

20. A control apparatus comprising:
at least one hardware processer configured to execute modules comprising a configurator configured to set a discovery period in which a first node transmits a first signal necessary for cell detection and radio measurement performed by an user equipment before a first cell controlled by the first node is turned on to transmit a second signal carrying user data for data communication between the first node and the user equipment.

21. The control apparatus according to claim 20, wherein the discovery period is a time period adjacent to an ON period in which the first node is allowed to transmit both the first signal and the second signal.

22. The control apparatus according to claim 21, wherein the discovery period immediately follows an OFF period and is immediately followed by the ON period, wherein the OFF period is a time period in which the first node transmits neither the first signal nor the second signal.

23. The control apparatus according to claim 20, wherein during the discovery period, the first node is not allowed to transmit the second signal.

24. The control apparatus according to claim 20, wherein the configurator is further configured to send configuration information of the discovery period to the first node.

25. The control apparatus according to claim 24, wherein the configuration information indicates at least one of the information of a starting time and a length of the discovery period.

26. The control apparatus according to claim 20, wherein the configurator is further configured to adjust a length of the discovery period applied to the first cell based on a traffic load of a second cell controlled by a second node different from the first node.

27. The control apparatus according to claim 26, wherein the configurator is further configured to reduce the length of the discovery period with decreasing the traffic load.

28. The control apparatus according to claim 20, wherein the configurator is further configured to adjust a length of the discovery period applied to the first cell depending on carrier frequencies of a first cell controlled by the first node and a second cell controlled by a second node different from the first node.

29. The control apparatus according to claim 28, wherein when the first cell and the second cell use different carrier frequencies, the length of the discovery period is longer than that when the first cell and the second cell use the same carrier frequency.

30. The control apparatus according to claim 20,
wherein during the discovery period, the configurator is further configured to send to the first node a signal to configure the first node as a secondary serving cell in carrier aggregation for the user equipment.

31. The control apparatus according to claim 30, wherein during the discovery period, the configurator is further configured to transmit, to the user equipment via a third cell controlled by a third node different from the first node, a signal to indicate a radio resource of the first cell allocated for the user equipment, wherein the radio resource is used for transmitting a message from the user equipment to the first node during an ON period in which the first node is allowed to transmit both the first signal and the second signal.

32. The control apparatus according to claim 20, wherein the configurator is further configured to transmit a signal to inform the user equipment of configuration information indicating a starting time of the discovery period.

33. The control apparatus according to claim 20, wherein the control apparatus is arranged in a base station, a gateway or an Operation, Administration and Maintenance (OAM) system.

34. A base station apparatus comprising:
at least one hardware processor configured to execute modules comprising:
a communicator configured to control a first cell and communicate with a user equipment in the first cell; and
a controller configured to receive configuration information of a discovery period from a network, the discovery period being a time period in which the base station apparatus transmits a first signal necessary for cell detection and radio measurement performed by the user equipment before the first cell is turned on to transmit a second signal carrying user data for data communication between the base station apparatus and the user equipment.

35. The base station apparatus according to claim 34, wherein the configuration information indicates at least one of the information of a starting time and a length of the discovery period.

36. The base station apparatus according to claim 34, wherein the discovery period is a time period adjacent to an ON period in which the base station apparatus is allowed to transmit both the first signal and the second signal.

37. The base station apparatus according to claim 36, wherein the discovery period immediately follows an OFF period and is immediately followed by the ON period, wherein the OFF period is a time period in which the base station apparatus transmits neither the first signal nor the second signal.

38. The base station apparatus according to claim 34, wherein during the discovery period, the base station apparatus is not allowed to transmit the second signal.

39. The base station apparatus according to claim 34, wherein during the discovery period, the controller is further configured to receive from the network a signal to configure the base station apparatus as a secondary serving cell in carrier aggregation for the user equipment.

40. A user equipment comprising:
at least one hardware processor configured to execute modules comprising
a communicator configured to communicate with a first cell and a second cell; and
a controller configured to receive, during a discovery period via the first cell, a signal indicating a radio resource of the second cell allocated for the user equipment, wherein the discovery period is a time period in which the first node transmits a first signal necessary for cell detection and radio measurement performed by the user equipment before the second cell is turned on to transmit a second signal carrying user data of the user equipment, and the radio resource is used for transmitting a message from the user equipment to the first cell during an ON period in which the second cell is allowed to transmit both the first and the second signal.

41. The user equipment according to claim 40, wherein the discovery period immediately follows an OFF period and is immediately followed by the ON period, wherein the OH period is a time period in which the second cell transmits neither the first signal nor the second signal.

42. A method for managing a base station, comprising:
setting a discovery period in which the base station transmits a first signal necessary for cell detection and radio measurement performed by the user equipment, before a first cell controlled by the base station is turned on to transmit a second signal carrying user data for data communication between the base station and the user equipment.

43. A method performed by a base station, comprising:
receiving configuration information of a discovery period from a network, the discovery period being a time period in which the base station transmits a first signal necessary for cell detection and radio measurement performed by a user equipment before a first cell controlled by the base station is turned on to transmit a second signal carrying user data for data communication between the base station and the user equipment.

44. A non-transitory computer-readable medium storing a program for causing a computer to carry out a method for managing a base station, wherein the method comprises setting a discovery period in which the base station transmits a first signal necessary for cell detection and radio measurement performed by the user equipment, before a first cell controlled by the base station is turned on to transmit a second signal carrying user data for data communication between the base station and the user equipment.

45. A non-transitory computer-readable medium storing a program for causing a computer to carry out a method performed by a base station, wherein the method comprises receiving configuration information of a discovery period from a network, the discovery period being a time period in which the base station transmits sends a first signal necessary for cell detection and radio measurement performed by a user equipment before a first cell controlled by the base station is turned on to transmit a second signal carrying user data for data communication between the base station and the user equipment.
